(19) United States
(12) Patent Application Publication
(10) Pub. No.: US 2002/0178344 A1
(43) Pub. Date: Nov. 28, 2002

(54) Apparatus for managing a multi-modal user interface

(75) Inventors: Marie-Luce Bourguet, London (GB); Uwe Helmut Jost, Berkshire (GB)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/152,284

(22) Filed: May 22, 2002

(30) Foreign Application Priority Data
May 22, 2001 (GB) 0112442.9

(51) Int. Cl. G06F 15/76

(52) U.S. Cl. 712/1

(57) ABSTRACT

The apparatus has a receiver (200) for receiving input events from at least two different modality modules (23 to 30); a plurality of instruction determining units (201b) each arranged to respond to a specific input event or specific combination of input events; and a supplier (201a) supplying events received by the receiver to the instruction determining units (23 to 30), wherein each instruction determining unit (23 to 30) is operable to supply a signal for causing a corresponding instruction to be issued when the specific input event or specific combination of input events to which that instruction determining unit is responsive is received by that instruction determining unit.

This invention relates to apparatus for managing a multi-modal user interface for, for example, a computer or computer or processor controlled device.

There is increasing interest in the use of multi-modal input to computers and computer or processor controlled devices. The common modes of input may include manual input using one or more of control buttons or keys, a keyboard, a pointing device (for example a mouse) and digitizing tablet (pen), spoken input, and video input such as, for example, lip, hand or body gesture input. The different modalities may be integrated in several different ways, dependent upon the content of the different modalities. For example, where the content of the two modalities is redundant, as will be the case for speech and lip movements, the input from one modality may be used to increase the accuracy of recognition of the input from the other modality. In other cases, the input from one modality may be complementary to the input from another modality so that the inputs from the two modalities together convey the command. For example, a user may use a pointing device to point to an object on a display screen and then utter a spoken command to instruct the computer as to the action to be taken in respect of the identified object. The input from one modality may also be used to help to remove any ambiguity in a command or message input using another modality. Thus, for example, where a user uses a pointing device to point at two overlapping objects on a display screen, then a spoken command may be used to identify which of the two overlapping objects is to be selected.

A number of different ways of managing multi-modal interfaces have been proposed. Thus, for example, a frame-based approach in which frames obtained from individual modality processors are merged in a multi-modal interpreter has been proposed by, for example, Nigay et al in a paper entitled “A Generic Platform for Addressing the Multi-Modal challenge” published in the CHI'95 proceedings papers. This approach usually leads to robust interpretation but postpones the integration until a late stage of analysis. Another multi-modal interface that uses a frame-based approach is described in a paper by Vo et al entitled “Building an Application Framework for Speech and Pen Input Integration in Multi-Modal Learning Interfaces” published at ITASSP'96, 1996. This technique uses an interpretation engine based on semantic frame merging and again the merging is done at a high level of abstraction.

Another approach to managing multi-modal interfaces is the use of multi-modal grammars to parse multi-modal inputs. Multi-modal grammars are described in, for example, a paper by M. Johnston entitled “Unification-based Multi-Modal Parsing” published in the proceedings of the 17^{th} International Conference on Computational Linquistics and the 36^{th} Annual Meeting of the Association for Computational Linguistics (COLING-ACL 1998), 1998 and in a paper by Shimazu entitled “Multi-Modal Definite Clause Grammar” published in Systems and Computers in Japan, Volume 26, No. 3, 1995.

Another way of implementing a multi-modal interface is to use a connectionist approach using a neural net as described in, for example, a paper by Waibel et al entitled “Connectionist Models in Multi-Modal Human Computer Interaction” from GOMAC 94 published in 1994.

In the majority of the multi-modal interfaces described above, the early stages of individual modality processing are carried out independently so that, at the initial stage of processing, the input from one modality is not used to assist in the processing of the input from the other modality and so may result in propagation of bad recognition of results.

In one aspect, the present invention provides apparatus for managing a multi-modal interface, which apparatus comprises:

means for receiving events from at least two different modality modules;

instruction providing means; and

means for supplying received events to the instruction providing means, wherein each instruction providing means is arranged to issue a specific instruction for causing an application to carry out a specific function only when a particular combination of input events is received.

In one aspect, the present invention provides apparatus for managing a multi-modal interface, which apparatus comprises:

a plurality of instruction providing means for each providing a specific different instruction for causing an application to carry out a specific function, wherein each instruction providing means is arranged to respond only to a specific combination of multi-modal events so that an instruction providing means is arranged to issue its instruction only when that particular combination of multi-modal events has been received.

In one aspect, the present invention provides apparatus for managing a multi-modal interface, which apparatus comprises:

means for receiving events from at least two different modality modules; and

processing means for processing events received from the at least two different modality modules, wherein the processing means is arranged to modify an input event or change its response to an event from one modality module in dependence upon an event from another modality module or modality modules.

In one aspect, the present invention provides apparatus for managing a multi-modal interface, which apparatus comprises:

means for receiving events from at least two different modality modules; and

processing means for processing events received from the at least two different modality modules, wherein the processing means is arranged to process an event from one modality module in accordance with an event from another modality module or modules and to provide a feedback signal to the one modality module to cause it to modify its processing of a user input in dependence upon an event from another modality module or modules.

In one aspect, the present invention provides apparatus for managing a multi-modal interface, which apparatus comprises:

means for receiving events from at least a speech input modality module and a lip reading modality module; and

processing means for processing events received from the speech input modality module and the lip reading modality module, wherein the processing means is arranged to activate the lip reading module when the processing means determines from an event received from the speech input modality module that the confidence score for the received event is low.

In one aspect, the present invention provides apparatus for managing a multi-modal interface, which apparatus comprises:

means for receiving input events from at least a face recognition modality module and a lip reading modality module for reading a user's lips; and

processing means for processing input events received from the face recognition modality module and the lip reading modality module, wherein the processing means is arranged to ignore an event input by the lip reading modality module when the processing means determines from an input event received from the face recognition modality module that the user's lips are obscured.

Embodiments of the present invention will now be described, by way of example, with reference to the accompanying drawings, in which:

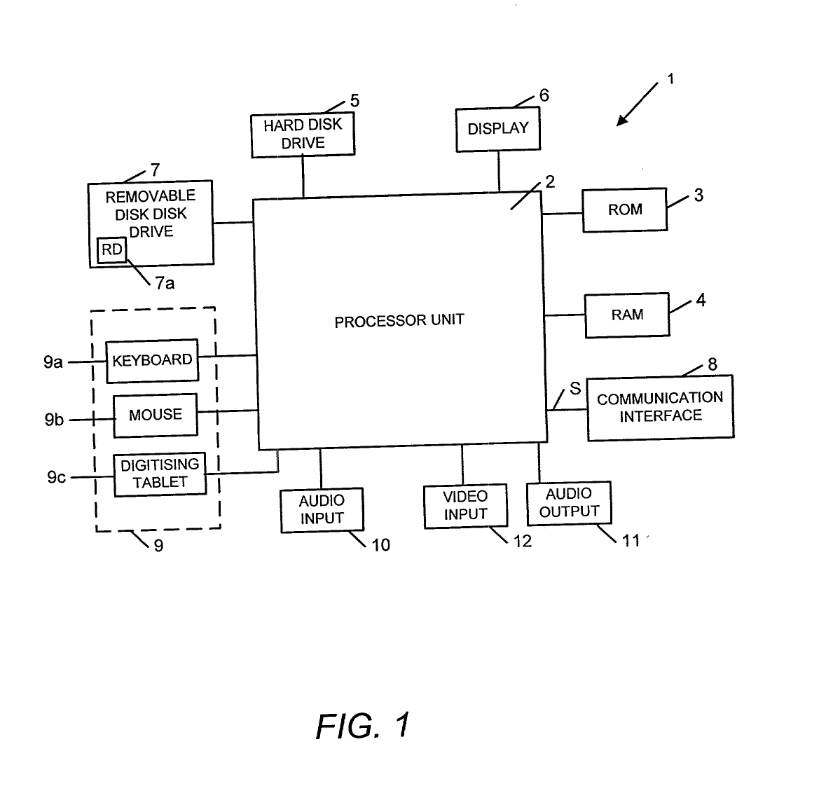

FIG. 1 shows a block schematic diagram of a computer system that may be used to implement apparatus embodying the present invention;

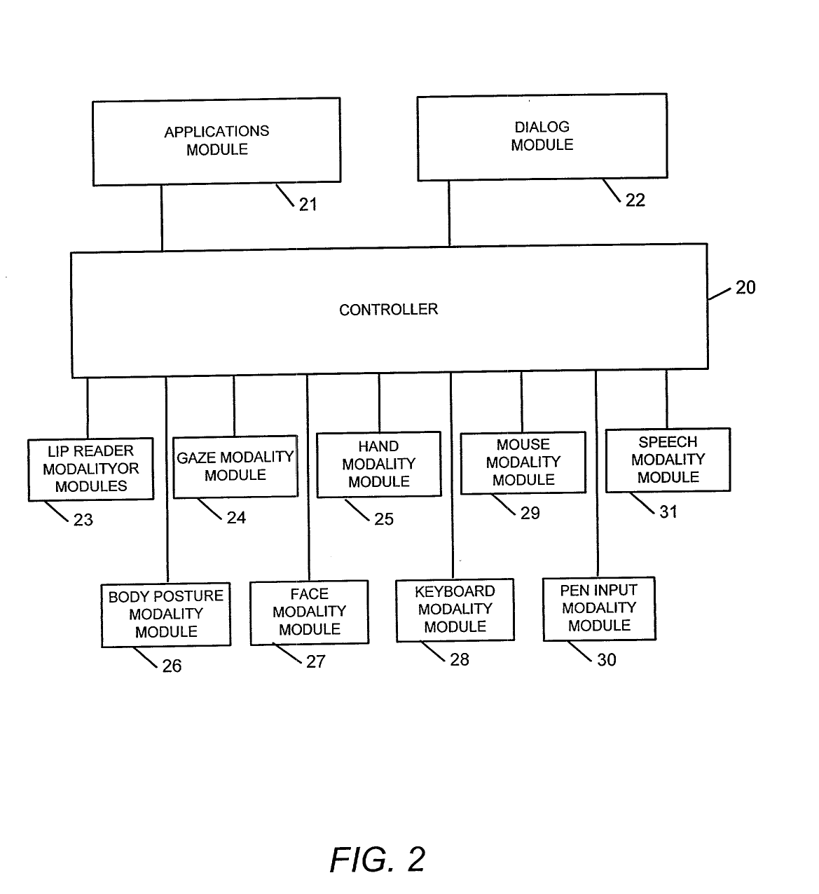

FIG. 2 shows a functional block diagram of apparatus embodying the present invention;

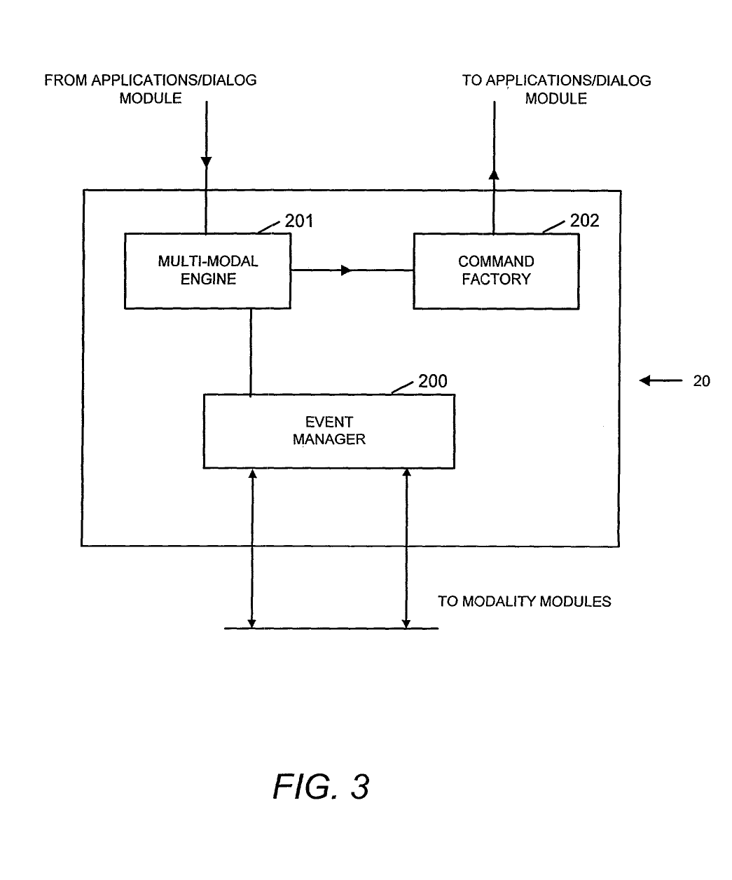

FIG. 3 shows a functional block diagram of a controller of the apparatus shown in FIG. 2;

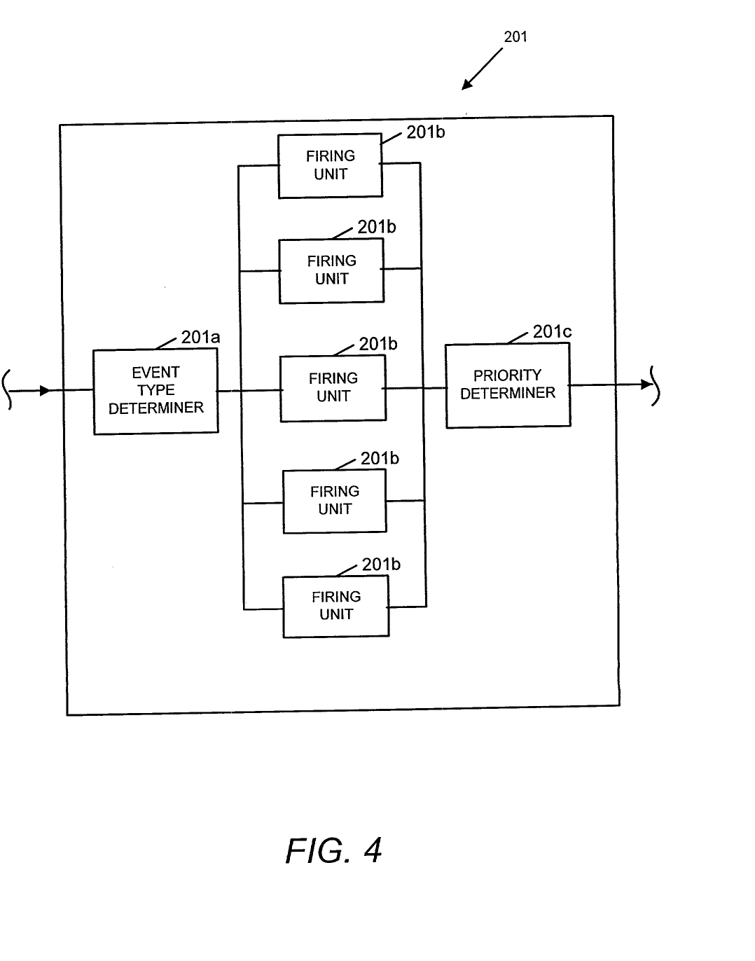

FIG. 4 shows a functional block diagram of a multi-modal engine of the controller shown in FIG. 3;

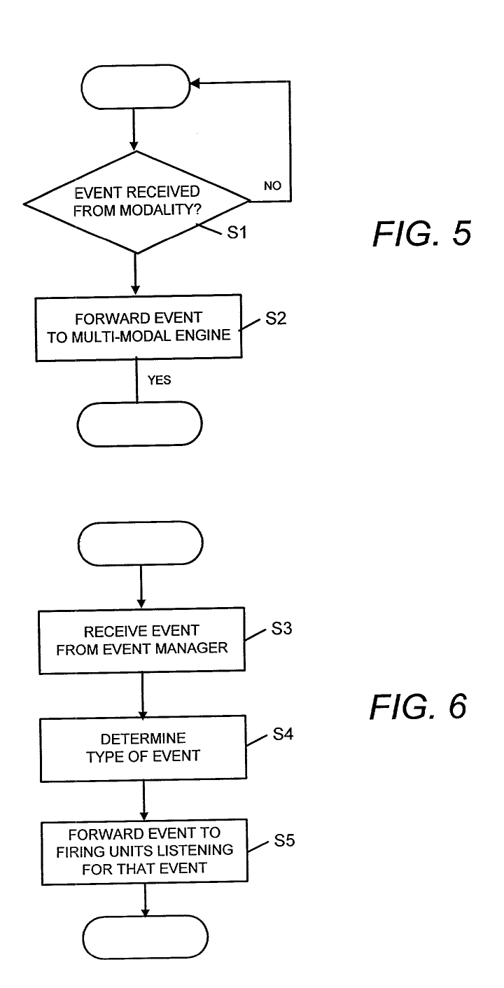

FIG. 5 shows a flow chart for illustrating steps carried out by an event manager of the controller shown in FIG. 3;

FIG. 6 shows a flow chart for illustrating steps carried out by an event type determiner of the multi-modal engine shown in FIG. 4;

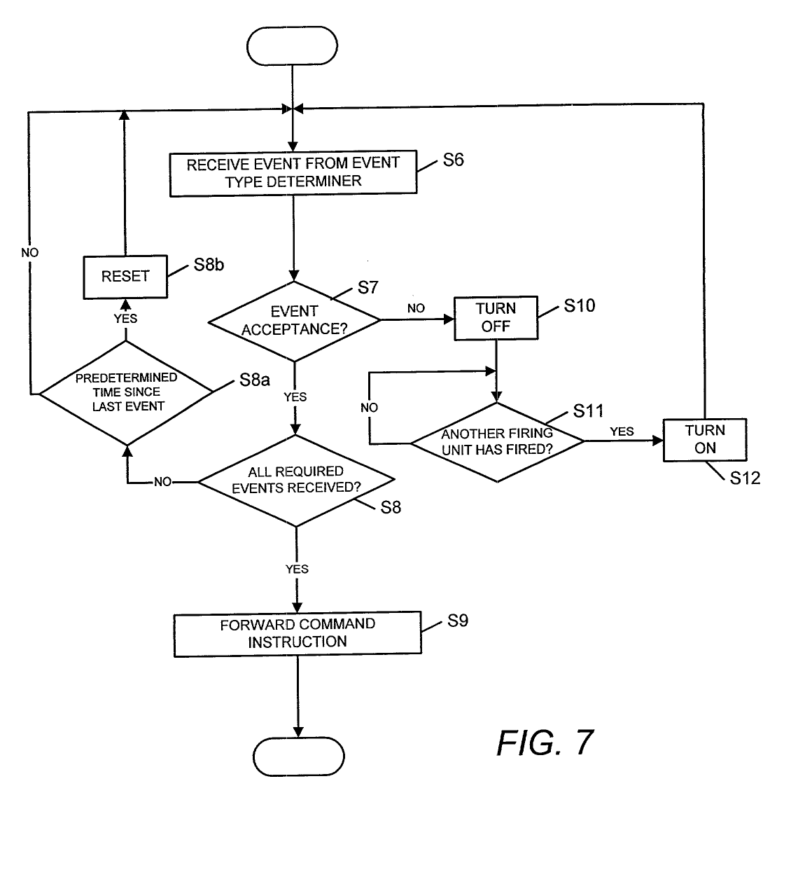

FIG. 7 shows a flow chart for illustrating steps carried out by a firing unit of the multi-modal engine shown in FIG. 4;

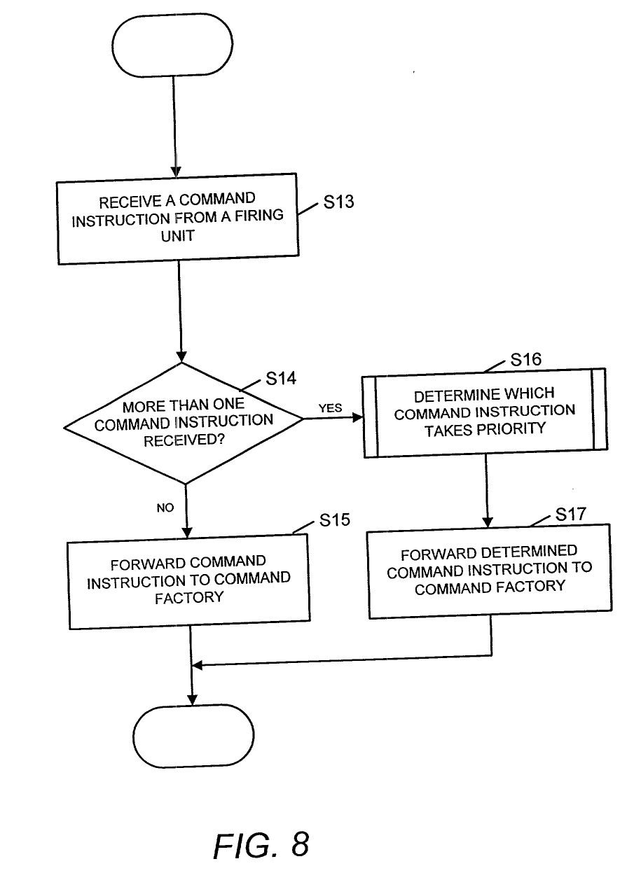

FIG. 8 shows a flow chart for illustrating steps carried out by a priority determiner of the multi-modal engine shown in FIG. 4;

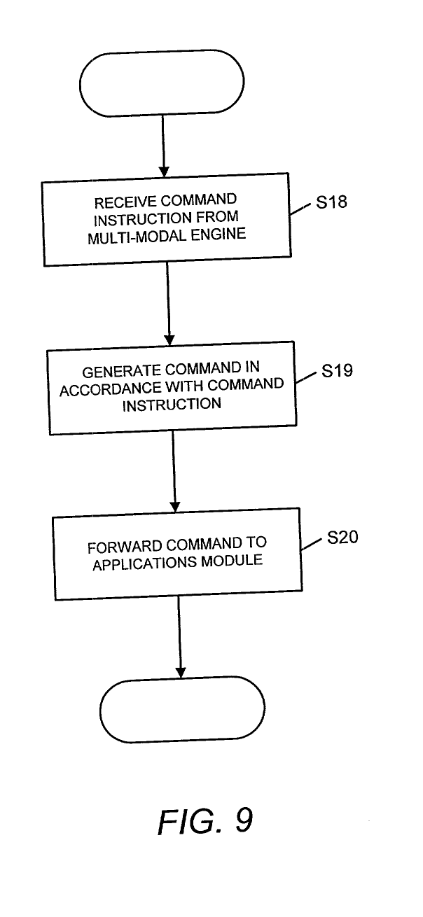

FIG. 9 shows a flow chart for illustrating steps carried out by a command factory of the controller shown in FIG. 3;

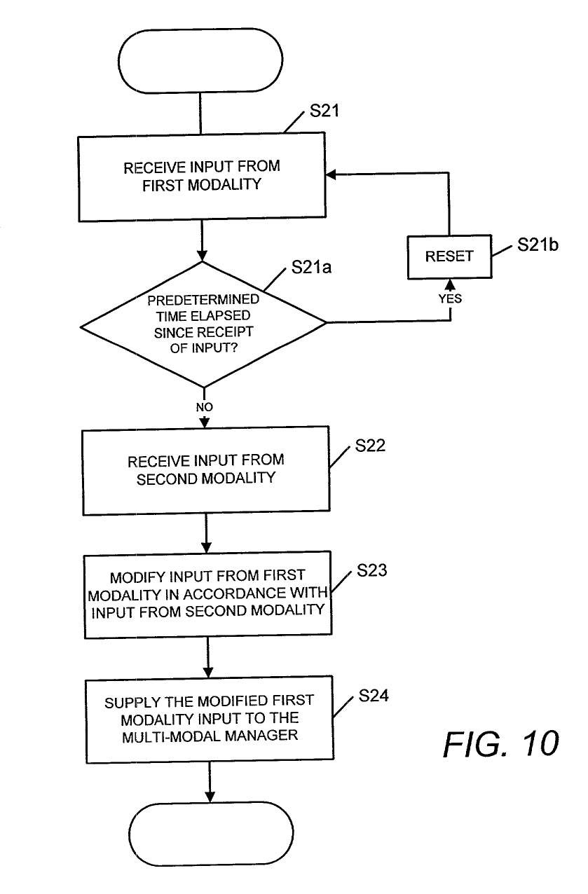

FIG. 10 shows a flow chart for illustrating steps carried out by a controller of apparatus embodying the invention;

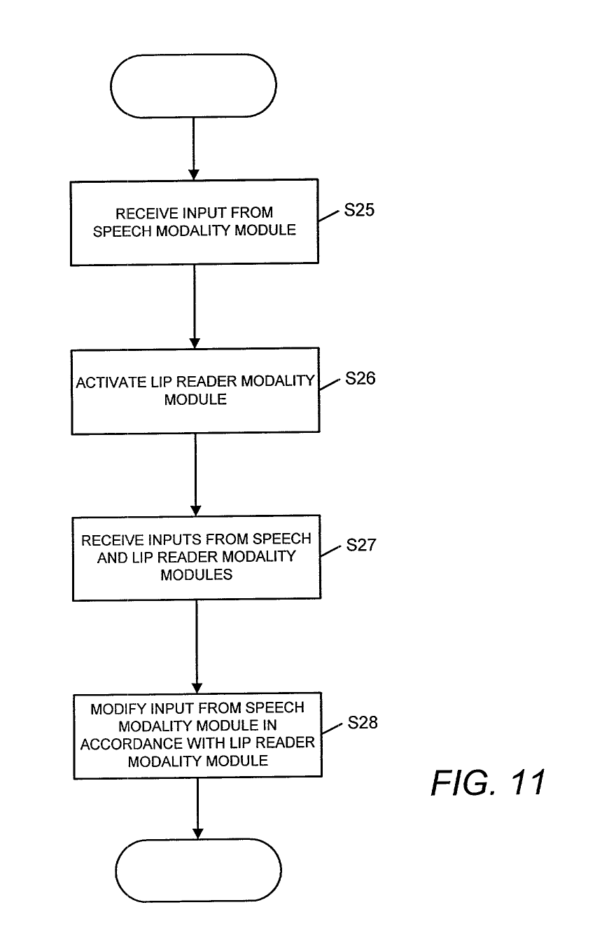

FIG. 11 shows a flow chart for illustrating steps carried out by a controller of apparatus embodying the invention when the input from a speech modality module is not satisfactory;

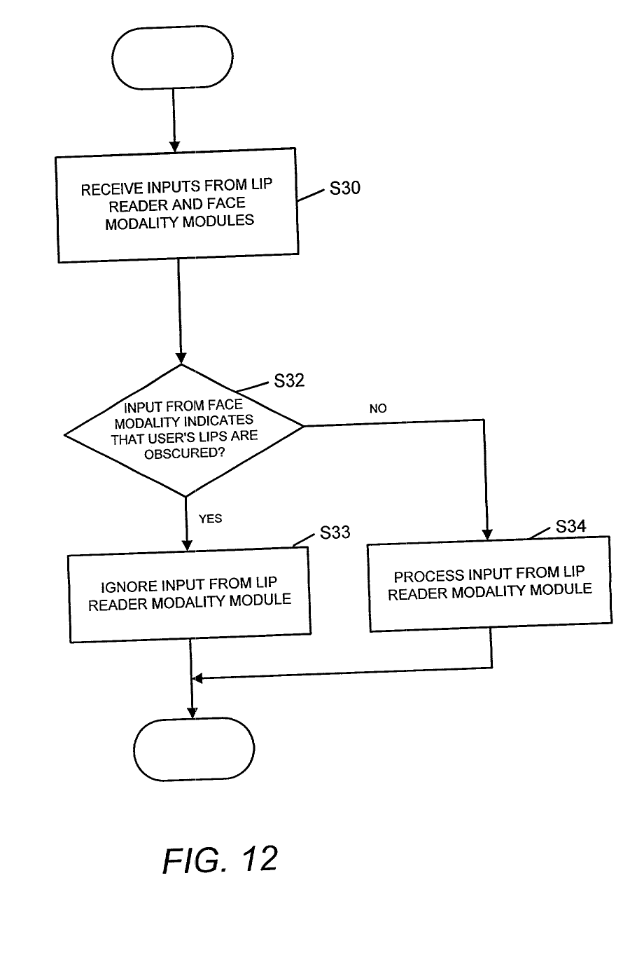

FIG. 12 shows a flow chart for illustrating steps carried out by a controller of apparatus embodying the invention in relation to input from a lip reader modality module;

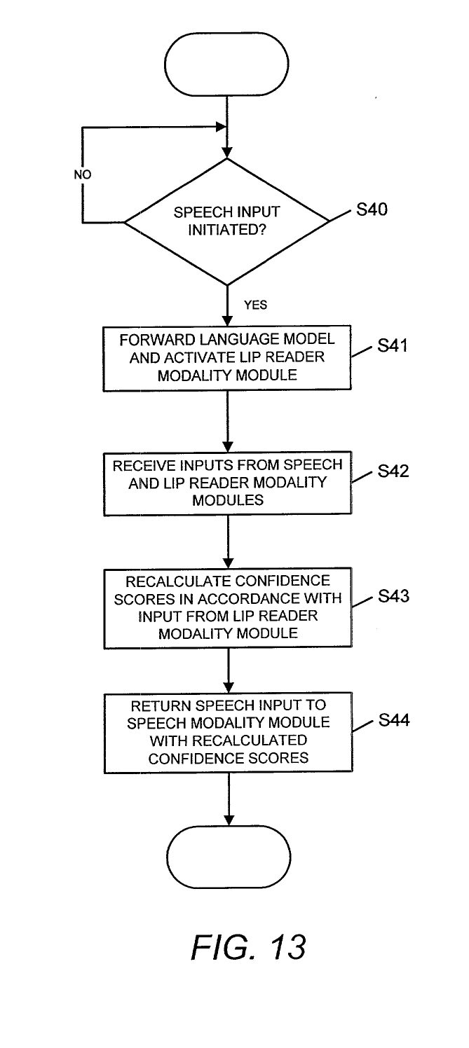

FIG. 13 shows a flow chart for illustrating use of apparatus embodying the invention to control the operating of a speech modality module;

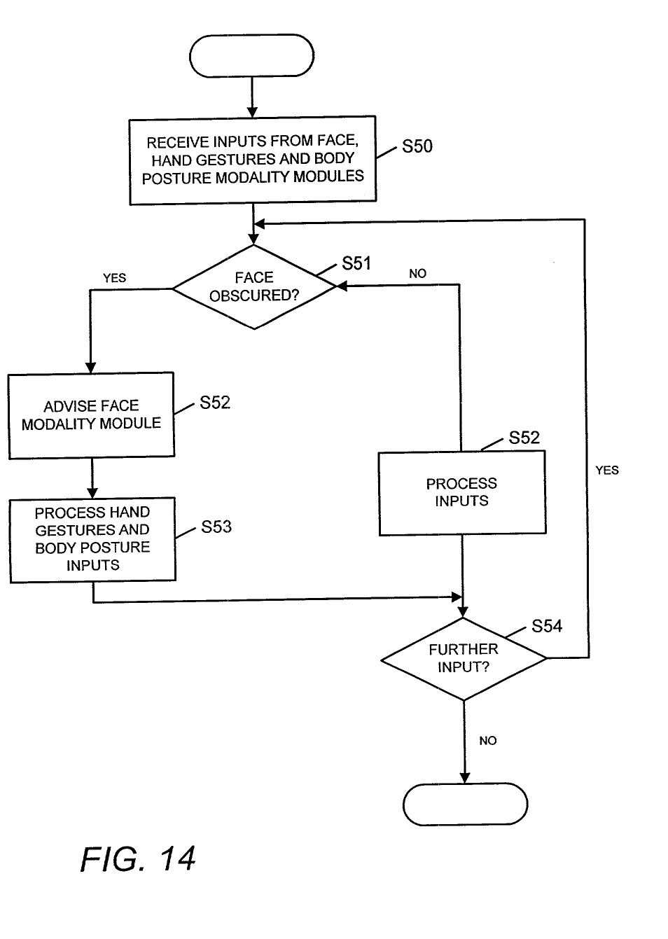

FIG. 14 shows a flow chart for illustrating steps carried out by a controller of apparatus embodying the invention for controlling the operation of a face modality module;

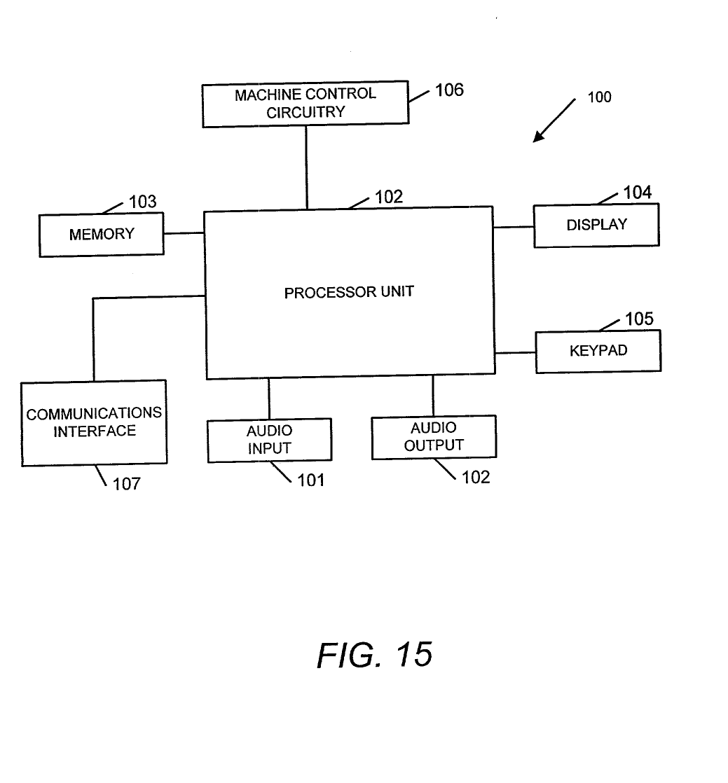

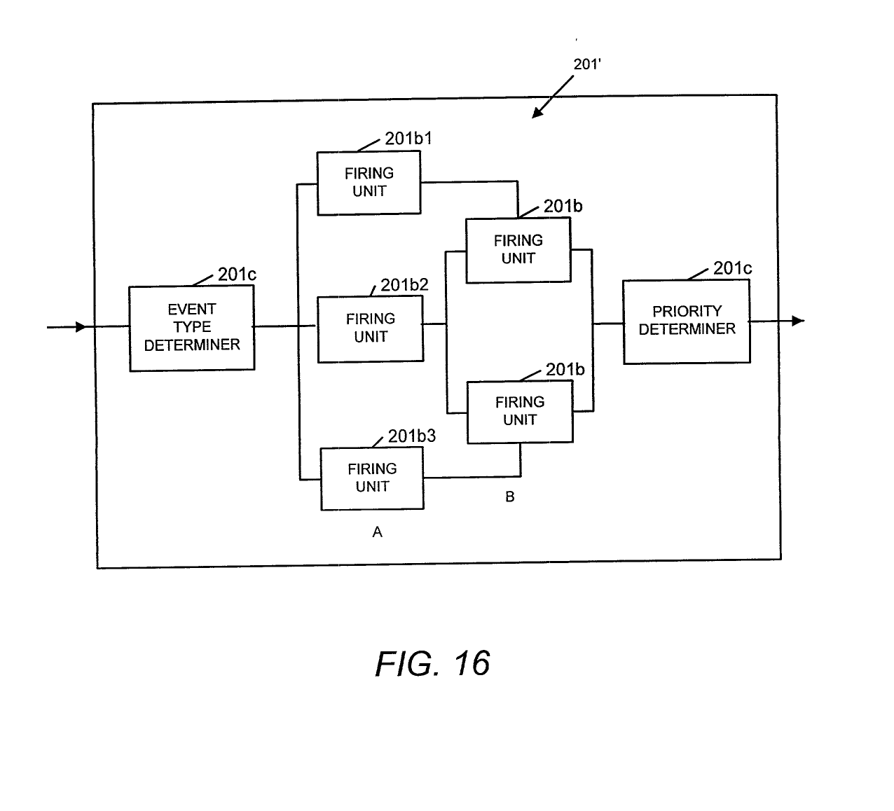

FIG. 15 shows a functional block diagram of a processor-controlled machine; and

FIG. 16 shows a block diagram of another example of a multi-modal engine.

Referring now to the drawings, FIG. 1 shows a computer system 1 that may be configured to provide apparatus embodying the present invention. As shown, the computer system 1 comprises a processor unit 2 associated with memory in the form of read only memory (ROM) 3 and random access memory (RAM) 4. The processor unit 2 is also associated with a hard disk drive 5, a display 6, a removable disk disk drive 7 for receiving a removable disk (RD) 7a, a communication interface 8 for enabling the computer system 1 to be coupled to another computer or to a network or, via a MODEM, to the Internet, for example. The computer system 1 also has a manual user input device 9 comprising at least one of a keyboard 9a, a mouse or other pointing device 9b and a digitizing tablet or pen 9c. The computer system 1 also has an audio input 10 such as the microphone, an audio output 11 such as a loudspeaker and a video input 12 which may comprise, for example, a digital camera.

The processor unit 2 is programmed by processor implementable instructions and/or data stored in the memory 3, 4 and/or on the hard disk drive 5. The processor implementable instructions and any data may be pre-stored in memory or may be downloaded by the processor unit 2 from a removable disk 7a received in the removable disk disk drive 7 or as a signal S received by the communication interface 8. In addition, the processor implementable instructions and any data may be supplied by any combination of these routes.

FIG. 2 shows a functional block diagram to illustrate the functional components provided by the computer system 1 when configured by processor implementable instructions and data to provide apparatus embodying the invention. As shown in FIG. 2, the apparatus comprises a controller 20 coupled to an applications module 21 containing application software such as, for example, word processing, drawing and other graphics software. The controller 20 is also coupled to a dialogue module 22 for controlling, in known manner, a dialog with a user and to a set of modality input modules. In the example shown in FIG. 2, the modality modules comprise a number of different modality modules adapted to extract information from the video input device 12. As shown, these consist of a lip reader modality module 23 for extracting lip position or configuration information from a video input, a gaze modality module 24 for extracting information identifying the direction of gaze of a user from the video input, a hand modality module 25 for extracting information regarding the position and/or configuration of a hand of the user from the video input, a body posture modality module 26 for extracting information regarding the overall body posture of the user from the video input and a face modality module 27 for extracting information relating to the face of the user from the video input. The modality modules also include manual user input modality modules for extracting manually input information. As shown, these include a keyboard modality module 28, a mouse modality module 29 and a pen or digitizing table modality module 30. In addition, the modality modules include a speech modality module 31 for extracting information from speech input by the user to the audio input 10.

Generally, the video input modality modules (that is the lip reader, gaze, hand, body posture and face modality modules) will be arranged to detect patterns in the input video information and to match those patterns to prestored patterns. For example, in the case of the lip reader modality module 23, then this will be configured to identify visemes which are lip patterns or configurations associated with parts of speech and which, although there is not a one-two-one mapping, can be associated with phonemes. The other modality modules which receive video inputs will generally also be arranged to detect patterns in the input video information and to match those patterns to prestored patterns representing certain characteristics. Thus, for example, in the case of the hand modality module 25, this modality module may be arranged to enable identification, in combination with the lip reader modality module 23, of sign language patterns. The keyboard, mouse and pen input modality modules will function in conventional manner while the speech modality module 31 will comprise a speech recognition engine adapted to recognise phonemes in received audio input in conventional manner.

It will, of course, be appreciated that not all of the modalities illustrated in FIG. 2 need be provided and that, for example, the computer system 1 may be configured to enable only manual and spoken input modalities or to enable only manual, spoken and lip reading input modalities. The actual modalities enabled will, of course, depend upon the particular functions required of the apparatus.

FIG. 3 shows a functional block diagram to illustrate functions carried out by the controller 20 shown in FIG. 2.

As shown in FIG. 3, the controller 20 comprises an event manager 200 which is arranged to listen for the events coming from the modality modules, that is to receive the output of the modality module, for example, recognised speech data in the case of the speech modality module 31 and x,y coordinate data in respect of the pen input modality module 30.

The event manager 200 is coupled to a multi-modal engine 201. The event manager 200 despatches every received event to the multi-modal engine 201 which is responsible for determining which particular application command or dialog state should be activated in response to the received event. The multi-modal engine 201 is coupled to a command factory 202 which is arranged to issue or create commands in accordance with the command instructions received from the multi-modal engine 201 and to execute those commands to cause the applications module 21 or dialog module 22 to carry out a function determined by the command. The command factory 202 consists of a store of commands which cause an associated application to carry out a corresponding operation or an associated dialog to enter a particular dialog state. Each command may be associated with a corresponding identification or code and the multi-modal engine 201 arranged to issue such codes so that the command factory issues or generates a single command or combination of commands determined by the code or combination of codes suggested by the multi-modal engine 201. The multi-modal engine 201 is also coupled to receive inputs from the applications and dialog modules that affect the functioning of the multi-modal engine.

FIG. 4 shows a functional block diagram of the multi-modal engine 201. The multi-modal engine 201 has an event type determiner 201a which is arranged to determine, from the event information provided by the event manager 200, the type, that is the modality, of a received event and to transmit the received event to one or more of a number of firing units 201b. Each firing unit 201b is arranged to generate a command instruction for causing the command factory 202 to generate a particular command. Each firing unit 201b is configured so as to generate its command instruction only when it receives from the event determiner 201a a specific event or set of events.

The firing units 201b are coupled to a priority determiner 201c which is arranged to determine a priority for command instructions should more than one firing unit 201b issue a command instruction at the same time. Where the application being run by the applications module is such that two or more firing units 201b would not issue command instructions at the same time, then the priority determiner may be omitted.

The priority determiner 201c (or the firing units 201b where the priority determiner is omitted) provide an input to the command factory 202 so that, when a firing unit 201b issues a command instruction, that command instruction is forwarded to the command factory 202.

The overall operation of the functional elements of the controller described above with reference to FIGS. 3 and 4 will now be described with reference to FIGS. 5 to 9.

FIG. 5 shows steps carried out by the event manager 200. Thus, at step S1 the event manager 200 waits for receipt of an event from a modality module and when an event is received for such a modality forwards the event to the multi-modal engine at step S2.

When, at step S3 in FIG. 6 the multi-modal engine receives an event from the events manager 200, then the event type determiner 201a determines from the received event the type of that event, that is its modality (step S4). The event type determiner 201a may be arranged to determine this from a unique modality module ID (identifier) associated with the received event. The event type determiner 201a then, at step S5, forwards the event to the firing unit or units 201b that are waiting for events of that type. Event type determiner 201a carries out steps S3 to S5 each time an event is received by the multi-modal engine 201.

When a firing unit 201b receives an event from the event type determiner at step S6 in FIG. 7, then the firing unit determines at step S7 whether the event is acceptable, that is whether the event is an event for which the firing unit is waiting. If the answer at step S7 is yes, then the firing unit determines at step S8 if it has received all of the required events. If the answer at step S8 is yes, then at step S9 the firing unit “fires” that is the firing unit forwards its command instruction to the priority determiner 201c or to the command factory 202 if the priority determiner 201c is not present. If the answer at step S8 is no, then the firing unit checks at step S8a the time that has elapsed since it accepted the first event. If a time greater than a maximum time (the predetermined time shown in FIG. 7) that could be expected to occur between related different modality events has elapsed, then the firing unit assumes that there are no modality events related to the already received modality event and, at step S8b resets itself, that is it deletes the already received modality event, and returns to step S6. This action assures that the firing unit only assumes that different modality events are related to one another (that is they relate to the same command or input from the user) if they occur within the predetermined time of one another. This should reduce the possibility of false firing of the firing unit.

Where the answer at step S7 is no, that is the firing unit is not waiting for that particular event, then at step S10, the firing unit turns itself off, that is the firing unit tells the event type determiner that it is not to be sent any events until further notice. Then, at step S11, the firing unit monitors for the firing of another firing unit. When the answer at step S11 is yes, the firing unit turns itself on again at step S12, that is it transmits a message to the event type determiner indicating that it is again ready to receive events. This procedure ensures that, once a firing unit has received an event for which it is not waiting, it does not need to react to any further events until another firing unit has fired.

FIG. 8 shows steps carried out by the priority determiner 201c. Thus, at step S13, the priority determiner receives a command instruction from a firing unit. At step S14, the priority determiner checks to see whether more than one command instruction has been received at the same time. If the answer at step S14 is no, then the priority determiner 201c forwards at step S15, the command instruction to the command factory 202. If, however, the answer at step S14 is yes, then the priority determiner determines at step S16 which of the received command instructions takes priority and at step S17 forwards that command instruction to the command factory. The determination as to which command instruction takes priority may be on the basis of a predetermined priority order for the particular command instructions, or may be on a random basis or on the basis of historical information, dependent upon the particular application associated with the command instructions.

FIG. 9 shows the steps carried out by the command factory. Thus, at step S18, the command factory receives a command instruction from the multi-modal engine then, at step S19, the command factory generates a command in accordance with the command instruction and then, at step S20, forwards that command to the application associated with that command. As will be come evident from the following, the command need not necessarily be generated for an application, but may be a command to the dialog module.

The events a firing unit 201b needs to receive before it will fire a command instruction will, of course, depend upon the particular application and the number and configuration of the firing units may alter for different states of a particular application. Where, for example, the application is a drawing package, then a firing unit may, for example, be configured to expect a particular type of pen input together with a particular spoken command. For example, a firing unit may be arranged to expect a pen input representing the drawing of a line in combination with a spoken command defining the thickness or colour of the line and will be arranged only to fire the command instruction to cause the application to draw the line with the required thickness and/or colour on the display to be issued when it has received from the pen input modality module 30 an event representing the drawing of the line and from the speech modality module 31 speech process data representing the thickness or colour command input by the user. Another firing unit may be arranged to expect an event defining a zig-zag type line from the pen input modality module and a spoken command “erase” from the speech modality module 31. In this case, the same pen inputs by a user would be interpreted differently, dependent upon the accompanying spoken commands. Thus, where the user draws a wiggly or zig-zag line and inputs a spoken command identifying a colour or thickness, then the firing unit expecting a pen input and a spoken command representing a thickness or colour will issue a command instruction from which the command factory will generate a command to cause the application to draw a line of the required thickness or colour on the screen. In contrast, when the same pen input is associated with the spoken input “erase” then the firing unit expecting those two events will fire issuing a command instruction to cause the command factory to generate a command to cause the application to erase whatever was shown on the screen at the area over which the user has drawn the zig-zag or wiggley line. This enables clear distinction between two different actions by the user.

Other firing units may be arranged to expect input from the mouse modality module 29 in combination with spoken input which enable one of a number of overlapping objects on the screen to be identified and selected. For example, a firing unit may be arranged to expect an event identifying a mouse click and an event identifying a specific object shape (for example, square, oblong, circle etc) so that that firing unit will only fire when the user clicks upon the screen and issues a spoken command identifying the particular shape required to be selected. In this case, the command instruction issued by the firing unit will cause the command factory to issue an instruction to the application to select the object of the shape defined by the spoken input data in the region of the screen identified by the mouse click. This enables a user to select easily one or a number of overlapping objects of different shapes.

Where a command may be issued in a number of different ways, for example using different modalities or different combinations of modalities, then there will be a separate firing unit for each possible way in which the command may be input.

In the apparatus described above, the dialog module 22 is provided to control, in known manner, a dialog with a user. Thus, initially the dialog module 22 will be in a dialog state expecting a first input command from the user and, when that input command is received, for example as a spoken command processed by the speech modality module 31, the dialog module 22 will enter a further dialog state dependent upon the input command. This further dialog state may cause the controller 20 or application module 22 to effect an action or may issue a prompt to the user where the dialog state determines that further information is required. User prompts may be provided as messages displayed on the display 6 or, where the processor unit is provided with speech synthesising capability and has as shown in FIG. 1 an audio output, a spoken prompt may be provided to the user. Although, FIG. 2 shows a separate dialog module 22, it will, of course, be appreciated that an application may incorporate a dialog manager and that therefore the control of the dialog with a user may be carried out directly by the applications module 21. Having a single dialog module 22 interfacing with the controller 20 and the applications module 21, does, however, allow a consistent user dialog interface for any application that may be run by the applications module.

As described above, the controller 20 receives inputs from the available modality modules and processes these so that the inputs from the different modalities are independent of one another and are only combined by the firing unit. The events manager 200 may, however, be programmed to enable interaction between the inputs from two or more modalities so that the input from one modality may be affected by the input from another modality before being supplied to the multi-modal engine 201 in FIG. 3.

FIG. 10 illustrates in general terms the steps that may be carried out by the event manager 200. Thus, at step S21 the events manager 200 receives an input from a first modality. At step S21a, the events manager determines whether a predetermined time has elapsed since receipt of the input from the first modality. If the answer is yes, then at step S21b, the event manager assumes that there are no other modality inputs associated with the first modality input and resets itself. If the answer at step S21a is no and at step S22 the events manager receives an input from a second modality then, at step S23, the events manager 200 modifies the input from the first modality in accordance with the input from the second modality before, at step S24, supplying the modified first modality input to the multi-modal manager. The modification of the input from a first modality by the input from a second modality will be effected only when the inputs from the two modalities are, in practice, redundant, that is the inputs from the two modalities should be supplying the same information to the controller 20. This would be the case for, for example, the input from the speech modality module 31 and the lip reader modality module 23.

FIGS. 11 and 12 show flow charts illustrating two examples of specific cases where the event manager 200 will modify the input from the one module in accordance with input received from another modality module.

In the example shown in FIG. 11, the events manager 200 is receiving at step S25 input from the speech modality module. As is known in the art, the results of speech processing may be uncertain, especially if there is high background noise. When the controller 20 determines that the input from the speech modality module is uncertain, then the controller 20 activates at step S26 the lip reader modality module and at step S27 receives inputs from both the speech and lip reader modality modules. Then at step S28, the events manager 200 can modify its subsequent input from the speech modality module in accordance with the input from the lip reader modality module received at the same time as input from the speech modality module. Thus, the events manager 200 may, for example, compare phonemes received from the speech modality module 31 with visemes received from the lip reader modality module 23, and where the speech modality module 31 presents more than one option with similar confidence skills, use the visemes information to determine which is the most or more likely of the possible phonemes.

FIG. 12 shows an example where the controller is receiving input from the lip reader modality module 23 and from the face modality module 27. The controller may be receiving these inputs in conjunction with input from the speech modality module so that, for example, the controller 20 may be using the lip reader modality module input to supplement the input from the speech modality module as described above. However, these steps will be the same as those shown in FIG. 10 and accordingly, FIG. 12 shows only the steps carried out by the event manager 200 in relation to the input from the lip reader modality module and from the face modality module. Thus, at step S30, the events manager 200 receives inputs from the lip reader modality module and the face modality module 27. The input from the lip reader modality module may be in the form of, as described above, visemes while the input from the face modality module may, as described above, be information identifying a pattern defining the overall shape of the mouth and eyes and eyebrows of the user. At step S32, the event manager 200 determines whether the input from the face modality module indicates that the user's lips are being obscured, that is whether, for example, the user has obscured their lips with their hand, or for example, with the microphone. If the answer at step S32 is yes, then the event manager 200 determines that the input from the lip reader modality module 23 cannot be relied upon and accordingly ignores the input from the lip reader module (step S33). If however, the answer at step S32 is no, then the event manager 200 proceeds to process the input from the lip reader modality module as normal. This enables, where the event manager 200 is using the input from the lip reader modality module to enhance the reliability of recognition of input from the speech modality module, the event manager 200 to, as set out in FIG. 12, use further input from the face modality module 27 to identify when the input from the lip reader modality module may be unreliable.

It will, of course, be appreciated that the method set out in FIG. 12 may also be applied where the controller 20 is receiving input from the hand modality module 25 instead of or in addition to the information from the face modality module if the information received from the hand modality module identifies the location of the hand relative to the face.

In the examples described with reference to FIGS. 10 to 12, the controller 20 uses the input from two or more modality modules to check or enhance the reliability of the recognition results from one of the modality modules, for example the input from the speech modality module.

Before supplying the inputs to the multi-modal engine 201, the event manager 200 may, however, also be programmed to provide feedback information to a modality module on the basis of information received from another modality module. FIG. 13 shows steps that may be carried out by the event manager 200 in this case where the two modality modules concerned are the speech modality module 31 and the lip reader modality module 23.

When, at step S40, the controller 20 determines that speech input has been initiated by, for example, a user clicking on an activate speech input icon using the mouse 9b, then at step S41, the controller forwards to the speech modality module a language module that corresponds to the spoken input expected from the user according to the current application being run by the applications module and the current dialog state determined by the dialogs module 22. At this step the controller 20 also activates the lip reader modality module 23.

Following receipt of a signal from the speech modality module 31 that the user has started to speak, the controller 20 receives inputs from the speech and lip reader modality modules 21 and 23 at step S42. In the case of the speech modality module, the input will consist of a continuous stream of quadruplets each comprising a phoneme, a start time, duration and confidence score. The lip reader input will consist of a corresponding continuous stream of quadruplets each consisting of a visemes, a start time, duration and confidence score. At step S43, the controller 20 uses the input from the lip reader modality module 23 to recalculate the confidence scores for the phonemes supplied by the speech modality module 31. Thus, for example, where the controller 20 determines, that for a particular start time and duration, the received visemes is consistent with a particular phoneme, then the controller will increase the confidence score for that phoneme whereas if the controller determines that the received visemes is inconsistent with the phoneme, then the controller will reduce the confidence score for that phoneme.

At step S44, the controller returns the speech input to the speech modality module as a continuous stream of quadruplets each consisting of a phoneme, start time, duration and new confidence score.

The speech modality module 31 may then further process the phonemes to derive corresponding words and return to the controller 20 a continuous stream of quadruplets each consisting of a word, start time, duration and confidence score with the words resulting from combinations of phonemes according to the language module supplied by the controller 20 at step S41. The controller 20 may then use the received words as the input from the speech modality module 31. However, where the speech recognition engine is adapted to provide phrases or sentences, the feedback procedure may continue so that, in response to receipt of the continuous stream of words quadruplets, the controller 20 determines which of the received words is compatible with the application being run, recalculates the confidence scores and returns a quadruplet word stream to the speech modality module which may then further process the received input to generate a continuous stream of quadruplets each consisting of a phrase, start time, duration and confidence score with the phrase being generated in accordance with the language module supplied by the controller. This method enables the confidence scores determined by the speech modality module 31 to be modified by the controller 20 so that the speech recognition process is not based simply on the information available to the speech modality module 31 but is further modified in accordance with information available to the controller 20 from, for example, a further modality input such as the lip reader modality module.

Apparatus embodying the invention may also be applied to sign language interpretation. In this case, at least the hand modality module 25, body posture modality module 26 and face modality module 27 will be present.

In this case, the controller 20 will generally be used to combine the inputs from the different modality modules 25, 26 and 27 and to compare these combined inputs with entries in a sign language database stored on the hard disk drive using a known pattern recognition technique. Where the lip reader modality module 23 is also provided, the apparatus embodying the invention may use the lip reader modality module 23 to assist in sign language recognition where, for example, the user is speaking or mouthing the words at the same time as signing them. This should assist in the recognition of unclear or unusual signs.

FIG. 14 shows an example of another method where apparatus embodying the invention may be of advantage in sign language reading. Thus, in this example, the controller 20 receives at step S50 inputs from the face, hand gestures and body posture modality modules 27, 25 and 26. At step S51, the controller 20 compares the inputs to determine whether or not the face of the user is obscured by, for example, one of their hands. If the answer at step S51 is no, then the controller 20 proceeds to process the inputs from the face, hand gestures and body posture modules to identify the input sign language for supply to the multi-modal manager. If, however, the answer at step S51 is yes, then at step S52, the controller 20 advises the face modality module 27 that recognition is not possible. The controller 20 may proceed to process the inputs from the hand gestures and body posture modality modules at step S53 to identify if at all possible, the input sign using the hand gesture and body posture inputs alone. Alternatively, the controller may cause the apparatus to instruct the user that the sign language cannot be identified because their face is obscured enabling the user to remove the obstruction and repeat the sign. The controller then checks at step S54 whether further input is still being received and if so, steps S51 to S53 are repeated until the answer at step S54 is no where the process terminates.

As mentioned above, apparatus embodying the invention need not necessarily provide all of the modality inputs shown in FIG. 2. For example, apparatus embodying the invention may be provided with manual user input modalities (mouth, pen and keyboard modality modules 28 to 30) together with the speech modality module 31. In this case, the input from the speech modality module may, as described above, be used to assist in recognition of the input of, for example, the pen or tablet input modality module. As will be appreciated by those skilled in the art, a pen gesture using a digitizing tablet is intrinistically ambiguous because more than one meaning may be associated with a gesture. Thus, for example, when the user draws a circle, that circle may correspond to a round shaped object created in the context of a drawing task, the selection of a number of objects in the context of an editing task, a zero figure, the letter O etc. In apparatus embodying the present invention, the controller 20 can use spoken input processed by the speech modality module 31 to assist in removing this ambiguity so that, by using the speech input together with the application context derived from the application module, the controller 20 can determine the intent of the user. Thus, for example, where the user says the word “circle” and at the same time draws a circle on the digitizing table, then the controller 20 will be able to ascertain that the input required by the user is the drawing of a circle on a document.

In the examples described above, the apparatus enables two-way communication with the speech modalities module 31 enabling the controller 20 to assist in the speech recognition process by, for example, using the input from another modality. The controller 20 may also enable a two-way communication with other modalities so that the set of patterns, visemes or phonemes as the case may be, from which the modality module can select a most likely candidate for a user input can be constrained by the controller in accordance with application contextual information or input from another modality module.

Apparatus embodying the invention enables the possibility of confusion or inaccurate recognition of a user's input to be reduced by using other information, for example, input from another modality module. In addition, where the controller determines that the results provided by a modality module are not sufficiently accurate, for example the confidence scores are too low, then the controller may activate another modality module (for example the lip reading modality module where the input being processed is from the speech modality module) to assist in the recognition of the input.

It will, of course, be appreciated that not all of the modality modules shown in FIG. 2 need be provided and that the modality modules provided will be dependent upon the function required by the user of the apparatus. In addition, as set out above, where the applications module 21 is arranged to run applications which incorporate their own dialog management system, then the dialog module 22 may be omitted. In addition, not all of the features described above need be provided in a single apparatus. Thus, for example, an embodiment of the present invention provides a multi-modal interface manager that has the architecture shown in FIGS. 3 and 4 but independently processes the input from each of the modality modules. In another embodiment, a multi-modal interface manager may be provided that does not have the architecture shown in FIGS. 3 and 4 but does enable the input from one modality module to be used to assist in the recognition process for another modality module. In another embodiment, a multi-modal interface manager may be provided which does not have the architecture shown in FIGS. 3 and 4 but provides a feedback from the controller to enable a modality module to refine its recognition process in accordance with information provided from the controller, for example, information derived from the input of another modality module.

As described above, the controller 20 may communicate with the dialog module 22 enabling a multi-modal dialog with the users. Thus, for example, the dialog manager may control the choice of input modality of modalities available to the user in accordance with the current dialog state and may control the activity of the firing unit so that the particular firing units that are active are determined by the current dialog state so that the dialog manager constrains the active firing units to be those firing units that expect an input event from a particular modality or modalities.

As mentioned above, the multi-modal user interface may form part of a processor-controlled device or machine which is capable of carrying out at least one function under the control of the processor. Examples of such processor-controlled machines are, in the office environment, photocopy and facsimile machines and in the home environment video cassette recorders, for example.

FIG. 15 shows a block diagram of such a processor-controlled machine, in this example, a photocopying machine.

The machine 100 comprises a processor unit 102 which is programmed to control operation of machine control circuitry 106 in accordance with instructions input by a user. In the example of a photocopier, the machine control circuitry will consist of the optical drive, paper transport and a drum, exposure and development control circuitry. The user interface is provided as a key pad or keyboard 105 for enabling a user to input commands in conventional manner and a display 104 such as an LCD display for displaying information to the user. In this example, the display 104 is a touch screen to enable a user to input commands using the display. In addition, the processor unit 102 has an audio input or microphone 101 and an audio output or loudspeaker 102. The processor unit 102 is, of course, associated with memory (ROM and/or RAM) 103.

The machine may also have a communications interface 107 for enabling communication over a network, for example. The processor unit 102 may be programmed in the manner described above with reference to FIG. 1. In this example, the processor unit 102 when programmed will provide functional elements similar to that shown in FIG. 2 and including conventional speech synthesis software. However, in this case, only the keyboard modality module 28, pen input modality module 30 (functioning as the touch screen input modality module) and speech modality module 31 will be provided and in this example, the applications module 21 will represent the program instructions necessary to enable the processor unit 102 to control the machine control circuitry 106.

In use of the machine 100 shown in FIG. 15, the user may use one or any one combination of the keyboard, touch screen and speech modalities as an input and the controller will function in the manner described above. In addition, a multi-modal dialog with the user may be effected with the dialog state of the dialog module 22 controlling which of the firing units 201b (see FIG. 4) is active and so which modality inputs or combinations of modality inputs are acceptable. Thus, for example, the user may input a spoken command which causes the dialog module 22 to enter a dialog state that causes the machine to display a number of options selectable by the user and possibly also to output a spoken question. For example, the user may input a spoken command such as “zoom to fill page” and the machine, under the control of the dialog module 22, may respond by displaying on the touch screen 104 a message such as “which output page size” together with soft buttons labelled, for example, A3, A4, A5 and the dialog state of the dialog module 22 may activate firing units expecting as a response either a touch screen modality input or a speech modality input.

Thus, in the case of a multi-modal dialog the modalities that are available to the user and the modalities that are used by the machine will be determined by the dialog state of the dialog of the dialog module 22 and the firing units that are active at a particular time will be determined by the current dialog state so that, in the example given above where the dialog state expects either a verbal or a touch screen input, then a firing unit expecting a verbal input and a firing unit expecting a touch screen input will be active.

In the above described embodiments, a firing units fires when it receives the specific event or set of events for which it is designed and, assuming that it is allocated priority by the priority determiner if present, results in a command instruction being sent to the command factory that causes a command to be issued to cause an action to be carried out by a software application being run by the applications module, or by the machine in the example shown in FIG. 15 or by the dialog module. Thus, a command instruction from a firing unit may cause the dialog module to change the state of a dialog with the user. The change of state of the dialog may cause a prompt to be issued to the user and/or different firing units to be activated to await input from the user. As another possibility where a firing unit issues a command instruction that causes a change in dialog state, then the firing unit itself may be configured to cause the dialog state to change. For example, in the case of the photocopying machine shown in FIG. 15, a “zoom to fill page” firing unit may when triggered by a spoken command “zoom to fill page” issue a command instruction that triggers the output devices, for example, a speech synthesiser and touch screen, to issue a prompt to the user to select a paper size. For example, the firing unit may issue a command instruction that causes a touch screen to display a number of soft buttons labelled, for example, A3, A4, A5 that may be selected by the user. At the same time firing units waiting for the event “zoom to fill A3 page”, “zoom to fill A4 page”, “zoom to fill A5 page” will wait for further input from, in this example, selection of a soft button by the user.

In the above described examples, the firing units are all coupled to receive the output of the event type determiner and are arranged in a flat non-hierarchical structure. However, a hierarchical structure may be implemented in which firing units are configured to receive outputs from other firing units. FIG. 16 shows a functional block diagram similar to FIG. 4 of another example of multi-modal engine 201′ in which a two-level hierarchical structure of firing units 201b is provided. Although FIG. 16 shows three firing units 201b in the lower level A of the hierarchy and two firing units in the upper level B, it is will of course, be appreciated that more or fewer firing units may be provided and that the hierarchy may consist of more than two levels.

One way in which such a hierarchical firing unit structure may be used will now be described with reference to the example described above where a user uses the pen input to draw a wavy line and specifies that the wavy line is a command to erase an underlined object by speaking the word “erase” or issues a command regarding the characteristics of a line to be drawn such as “thick”, “red”, “blue” and so on. In this example, one of the firing units 201b1 is configured to fire in response to receipt of an input representing the drawing of a wavy line, one of the firing units 201b2 is configured to fire in response to receipt of the spoken word “erase” and the other of the firing unit 201b3 in the lower level A is configured to fire in response to receipt of the spoken command “thick”. In the upper level the firing unit 201b is configured to fire in response to receipt of inputs from the firing units 201b1 and 201b2, that is to issue a command instruction that causes an object beneath the wavy line to be erased while the other firing unit 201b is configured to fire in response to receipt of inputs from the firing units 201b2 and 201b3 that is to issue a command instruction that causes a thick line to be drawn.

Providing a hierarchical structure of firing units enables the individual firing units to be simpler in design and avoids duplications between firing units.

As another possibility, the firing units need not necessarily be arranged in the hierarchical structure but may be arranged in groups or “meta firing units” so that, for example, input of an event to one firing unit within the group causes that firing unit to activate other firing units within the same group and/or to provide an output to one or more of those firing units. Thus, activation of one or more firing units may be dependent upon activation of one or more other firing units.

As an example, activation of a “zoom to fill page” firing unit may activate, amongst others, a “zoom to fill A3 page” meta unit which causes the issuing of a user prompt (for example a spoken prompt or the display of soft buttons) prompting the user to select a paper size A3, A4, A5 and so on and which also activates firing units configured to receive events representing input by the user of paper size data for example, A3, A4 and A5 button activation firing units and then, when input is received from one of those firing units, issues a command instruction to zoom to the required page size.

In the above described embodiments, the events consist of user input. This need not necessarily be the case and, for example, an event may originate with a software application being implemented by the applications module or by the dialog being implemented by the dialog module 22 and/or in the case of a processor controlled machine, from the machine being controlled by the processor. Thus, the multi-modal interface may have, in effect, a software applications modality module, a dialog modality module and one or more machine modality modules. Examples of machine modality modules are modules that provide inputs relating to events occurring in the machine that require user interaction such as, for example, “out of toner”, “paper jam”, “open door” and similar signals in a photocopying machine. As an example, a firing unit or firing unit hierarchy may provide a command instruction to display a message to the user that “there is a paper jam in the duplexing unit, please open the front door”, in response to receipt by the multi-modal interface of a device signal indicating a paper jam in the duplexing unit of a photocopying machine and at the same time activate a firing unit or firing unit hierarchy or meta firing unit group expecting a machine signal indicating the opening of the front door. In addition, because users can often mistakenly open the incorrect door, firing units may be activated that expects machine signals from incorrectly opened doors of the photocopying machine so that if, for example, the user responds to the prompt by incorrectly opening the toner door, then the incorrect toner door opening firing unit will be triggered to issue a command instruction that causes a spoken or visual message to be issued to the user indicating that “no this is the toner cover door, please close it and open the other door at the front”.

In the above described examples, the priority determiner determines the command instruction that takes priority on the basis of a predetermined order or randomly, or on the base of historical information. The priority determiner may also take into account confidence scores or data provided by the input modality modules as described above, which confidence information may be passed to the priority determiner by the firing unit triggered by that event. For example, in the case of a pattern recogniser such as will be used by the lip reader, gaze, hand, body posture and face modality modules discussed above, then the pattern recogniser will often output multiple hypotheses or best guesses and different firing units may be configured to respond to different ones of these hypothesis and to provide with the resulting command instruction confidence data or scores so that the priority determiner can determine, on the basis of the relative confidence scores, which command instruction to pass to the command factory. As another possibility, selection of the hypothesis on the basis of the relative confidence scores of different hypotheses may be conducted within the modality module itself.

The configuration of the firing units in the above described embodiments may be programmed using a scripting language such as XML (Extensible Mark-up Language) which allows modality independent prompts and rules for modality selection or specific output for specific modality to be defined.

1. Apparatus for managing a multi-modal interface, which apparatus comprises:
receiving means for receiving events from at least two different modality modules;
a plurality of instruction determining means each arranged to respond to a specific event or specific combination of events; and
supplying means for supplying events received by the receiving means to the instruction determining means, wherein each instruction determining means is operable to supply a signal for causing a corresponding instruction to be issued when the specific event or specific combination of events to which that instruction determining means is responsive is received by that instruction determining means.

2. Apparatus according to claim 1, wherein the supplying means comprises event type determining means for determining the modality of a received event and for supplying the received event to the or each instruction determining means that is responsive to an event of that modality or to a combination of events including an event of that modality.

3. Apparatus according to claim 1, wherein when an instruction determining means is arranged to be responsive to a specific combination of events, the instruction determining means is arranged to be responsive to that specific combination of events if the events of that combination are all received within a predetermined time.

4. Apparatus according to claim 1, wherein each instruction determining means is arranged to switch itself off if a received event is one to which it is not responsive until another instruction determining means has supplied a signal for causing an instruction to be issued.

5. Apparatus according to claim 1, further comprising priority determining means for determining a signal priority when two or more of the instruction determining means supply signals at the same time.

6. Apparatus according to claim 5, wherein the priority determining means is arranged to determine a signal priority using confidence data associated with the signal.

7. Apparatus according to claim 1, further comprising command generation means for receiving signals from said instruction determining means and for generating a command corresponding to a received signal.

8. Apparatus according to any one of the preceding claims, further comprising event managing means for listening for events and for supplying events to the receiving means.

9. Apparatus according to claim 1, further comprising at least one operation means controllable by instructions caused to be issued by a signal from an instruction determining means.

10. Apparatus according to claim 9, wherein said at least one operation means comprises means running application software.

11. Apparatus according to claim 9, wherein said at least one operation means comprises control circuitry for carriing out a function.

12. Apparatus according to claim 11, wherein the control circuitry comprises control circuitry for carrying out a photocopying function.

13. Apparatus according to claim 9, wherein said at least one operation means comprises dialog means for conducting a multi-modal dialog with a user, wherein a dialog state of said dialog means is controllable by instructions caused to be issued by said instruction determining means.

14. Apparatus according to claim 1, further comprising managing means responsive to instructions received from an application or dialog to determine the event or combination of events to which the instruction determining means are responsive.

15. Apparatus according to claim 1, further comprising control means for modifying an event or changing a response to an event from one modality module in accordance with an event from another modality module or modules.

16. Apparatus according to claim 1, further comprising means for providing a signal to one modality module to cause that modality module to modify its processing in dependence upon an event received from another modality module or modules.

17. Apparatus for managing a multi-modal interface, which apparatus comprises:
a plurality of instruction providing means for each providing a specific different instruction for causing an application to carry out a specific function, wherein each instruction providing means is arranged to respond only to a specific combination of multi-modal events so that an instruction providing means is arranged to issue its instruction only when that particular combination of multi-modal events has been received.

18. Apparatus for managing a multi-modal interface, which apparatus comprises:
means for receiving events from at least two different modality modules; and
processing means for processing events received from the at least two different modality modules, wherein the processing means is arranged to modify an event or change its response to an event from one modality module in dependence upon an event from another modality module or modality modules.

19. Apparatus for managing a multi-modal interface, which apparatus comprises:
means for receiving events from at least two different modality modules; and
processing means for processing events received from the at least two different modality modules, wherein the processing means is arranged to process an event from one modality module in accordance with an event from another modality module or modules and to provide a feedback signal to the one modality module to cause it to modify its processing of a user input in dependence upon an event from another modality module or modules.

20. A method of operating a processor apparatus to manage a multi-modal interface, which method comprises the processor apparatus carrying out the steps of:
receiving events from at least two different modality modules;
providing a plurality of instruction determining means each arranged to respond to a specific event or specific combination of events; and
supplying received events to the instruction determining means so that an instruction determining means supplies a signal for causing a corresponding instruction to be issued when the specific event or specific combination of events to which that instruction determining means is responsive is received.

21. A method according to claim 20, wherein the supplying step comprises determining the modality of a received event and supplying the received event to the or each instruction determining means that is responsive to an event of that modality or to a combination of events including an event of that modality.

22. A method according to claim 20, wherein when an instruction determining means is responsive to a specific combination of events, the instruction determining means responds to that specific combination of events if the events of that combination are all received within a predetermined time.

23. A method according to claim 20, wherein each instruction determining means switches itself off if a received event is one to which it is not responsive until another instruction determining means has supplied a signal for causing an instruction to be issued.

24. A method according to claim 20, further comprising determining a signal priority when two or more of the instruction determining means supply signals at the same time.

25. A method according to claim 20, further comprising receiving signals from said instruction determining means and generating a command corresponding to a received signal.

26. A method according to claim 20, wherein the receiving step comprises listening for events and supplying events to the receiving means.

27. A method according to claim 20, further comprising controlling at least one operation means by instructions caused to be issued by a signal from an instruction determining means.

28. A method according to claim 27, wherein the controlling step comprises controlling at least one operation means comprising means running application software.

29. A method according to claim 27, wherein the controlling step controls at least one operation means comprising control circuitry for carrying out a function.

30. A method according to claim 29, wherein the controlling step comprises controlling control circuitry for carrying out a photocopying function.

31. A method according to claim 27, wherein said controlling step controls at least one operation means comprising dialog means for conducting a multi-modal dialog with a user so that a dialog state of said dialog means is controlled by instructions caused to be issued by said instruction determining means.

32. A method according to claim 20, further comprising the step of determining the event or combination of events to which the instruction determining means are responsive in accordance with instructions received from an application or dialog.

33. A method according to claim 20, further comprising the step of modifying an event or changing a response to an event from one modality module in accordance with an event from another modality module or modules.

34. A method according to claim 20, further comprising the step of providing a signal to one modality module to cause that modality module to modify its operation in dependence upon an event received from another modality module or modules.

35. A method of operating a processor apparatus to manage a multi-modal interface, which method comprises the processor apparatus providing a plurality of instruction providing means for each providing a specific different instruction for causing an application to carry out a specific function, so that each instruction providing means responds only to a specific combination of multi-modal events and issues its instruction only when that particular combination of multi-modal events has been received.

36. A method of operating a processor apparatus to manage a multi-modal interface, which method comprises the processor apparatus carrying out the steps of:
receiving events from at least two different modality modules;
processing events received from the at least two different modality modules, and modifying an event or changing its response to an event from one modality module in dependence upon an event from another modality module or modality modules.

37. A method of operating a processor apparatus to manage a multi-modal interface, which method comprises the processor apparatus carrying out the steps of:
receiving events from at least two different modality modules; and
providing a feedback signal to the one modality module to cause it to modify its processing in dependence upon an event from another modality module or modules.

38. A multi-modal interface having apparatus in accordance with claim 1.

39. A processor-controlled machine having a multi-modal interface in accordance with claim 38.

40. A processor-controlled machine having apparatus in accordance with claim 1.

41. A processor-controlled machine according to claim 39 arranged to carry out at least one of photocopying and facsimile functions.

42. A signal carrying processor instructions for causing a processor to implement a method in accordance with claim 1.

43. A storage medium carrying processor implementable instructions for causing processing means to implement a method in accordance with claim 1.

44. Apparatus for managing a multi-modal interface, which apparatus comprises:
a receiver for receiving events from at least two different modality modules;
a plurality of instruction determining units each arranged to respond to a specific event or specific combination of events; and
a supplier for supplying events received by the receiver to the instruction determining units, wherein each instruction determining unit is operable to supply a signal for causing a corresponding instruction to be issued when the specific event or specific combination of events to which that instruction determining unit is responsive is received by that instruction determining unit.

45. Apparatus for managing a multi-modal interface, which apparatus comprises:
a plurality of instruction providing units for each providing a specific different instruction for causing an application to carry out a specific function, wherein each instruction providing unit is arranged to respond only to a specific combination of multi-modal events so that an instruction providing unit is arranged to issue its instruction only when that particular combination of multi-modal events has been received.

46. Apparatus for managing a multi-modal interface, which apparatus comprises:
a receiver for receiving events from at least two different modality modules; and
a processor for processing events received from the at least two different modality modules, wherein the processor is arranged to modify an event or change its response to an event from one modality module in dependence upon an event from another modality module or modality modules.

47. Apparatus for managing a multi-modal interface, which apparatus comprises:
a receiver for receiving events from at least two different modality modules; and
a processor for processing events received from the at least two different modality modules, wherein the processor is arranged to process an event from one modality module in accordance with an event from another modality module or modules and to provide a feedback signal to the one modality module to cause it to modify its processing in dependence upon an event from another modality module or modules.
